(19) United States
(12) Patent Application Publication
(10) Pub. No.: US 2016/0059585 A1
(43) Pub. Date: Mar. 3, 2016

(54) MANUFACTURING METHOD FOR PRINTED MATTER

(71) Applicant: MIMAKI ENGINEERING CO., LTD., NAGANO (JP)

(72) Inventors: MASARU OHNISHI, NAGANO (JP); AKIFUMI SEKI, NAGANO (JP)

(21) Appl. No.: 14/830,725

(22) Filed: Aug. 19, 2015

(30) Foreign Application Priority Data
Aug. 26, 2014 (JP) 2014-172088

(51) Int. Cl. B41J 11/00

(52) U.S. Cl. CPC B41J 11/0015

(57) ABSTRACT

Provided is a manufacturing method for a printed matter that can fully take advantage of the useful features of latex inks even with recording media having irregular surfaces. A manufacturing method for a printed matter according to the present disclosure may advantageously produce a printed matter by performing an undercoat layer forming step of applying an undercoat ink on a recording medium to form an undercoat layer; and a latex ink applying step, subsequent to the undercoat layer forming step, of applying a latex ink containing a resin dispersed in a solvent on the undercoat layer.

### CROSS REFERENCE TO RELATED APPLICATIONS

This application claims the priority benefit of Japanese Patent Application No. 2014-172088, filed on Aug. 26, 2014. The entirety of the above-mentioned patent application is hereby incorporated by reference herein and made a part of this specification.

### TECHNICAL FIELD

The present disclosure relates to a manufacturing method for a printed matter.

### DESCRIPTION OF THE BACKGROUND ART

Patent Document 1 describes a veneer having a jet ink-printed layer on the surface of a base material, wherein the jet ink-printed layer is formed by applying and curing an ionization radiation-curing ink.

[Patent Document 1] JP 2001-26099 A (disclosed on Jan. 30, 2001).

### SUMMARY

Currently, latex inks are considered useful and well-accepted for their advantages described below. The latex inks are known for their low environmental load. Among the latex inks, aqueous latex inks that account for most of them are particularly environment-friendly. Further advantageously, the latex inks are capable of producing dark colors with thin layers.

However, there is a problem with the method described in Patent Document 1 (JP 2001-26099 A) as follows. Using a recording medium with surface irregularity such as a fibrous product, for example, the ink may be entrapped in dents on its irregular surface. This negates the advantageous ability of the latex inks to produce dark colors by using thin layers.

The present disclosure was accomplished to solve the problem. The present disclosure provides a manufacturing method for a printed matter that can fully take advantage of the useful features of latex inks even with recording media having irregular surfaces.

The inventors of the present disclosure earnestly worked on solutions for the problem, and finally accomplished the present disclosure.

A manufacturing method for a printed matter according to the present disclosure advantageously produces a printed matter by performing an undercoat layer foil ring step of applying an undercoat ink on a recording medium to form an undercoat layer; and a latex ink applying step, subsequent to the undercoat layer forming step, of applying a latex ink containing a resin dispersed in a solvent on the undercoat layer.

According to the above manufacturing method, since the undercoat layer is formed and the latex ink is then applied thereon, even when a recording medium with surface irregularity is used, the surface can become less irregular. This manufacturing method can thus flatten the medium surface or render the surface as flat as possible. By printing an image with the latex ink on the undercoat layer, the image can be printed well in a thinner layer than images printed in the absence of such an undercoat layer. Thus, recording media with surface irregularity can fully take advantage of the useful features of the latex ink.

In the manufacturing method for the printed matter according to the present disclosure, in the undercoat layer forming step, the undercoat ink is preferably applied on the recording medium horizontally situated to such an extent that the undercoat ink reaches a point of height equal to or above a highest point of surface irregularity of the recording medium.

This step can succeed in flattening the surface of the recording medium. Accordingly, since the latex ink can be applied on the flattened surface, a layer formed by the latex can be thinner and flatter. In this manner, the useful features of the latex ink can be fully exploited.

In the manufacturing method for the printed matter according to the present disclosure, the undercoat layer forming step is preferably performed at a temperature between room temperature and 40° C.

By avoiding high temperatures during the step, energy-saving effect can be expected. Further advantageously, the risk of crimping the recording medium can be avoided.

In the manufacturing method for the printed matter according to the present disclosure, the latex ink may preferably be an aqueous latex ink.

The aqueous latex ink is an even safer material with lower environmental load. Such an aqueous latex ink, therefore, may be suitable for perform printing on labels and seals adhered to, for example, food containers.

In the manufacturing method for the printed matter according to the present disclosure, the undercoat ink may preferably be a latex ink.

The latex ink is a material that can be well-adhered to various types of recording media. The latex ink, therefore, may be used for printing with various types of recording media.

The manufacturing method for the printed matter according to the present disclosure described so far can fully take advantage of the useful features of the latex ink, even with recording media having irregular surfaces.

### BRIEF DESCRIPTION OF THE DRAWINGS

FIGS. 1A-1C are schematic drawings of steps of a manufacturing method for a printed matter according to an embodiment of the present disclosure.

### DETAILED DESCRIPTION OF EMBODIMENTS

[Manufacturing Method for the Printed Matter]

A manufacturing method for a printed matter according to the present disclosure includes: an undercoat layer forming step of applying an undercoat ink on a recording medium to form an undercoat layer; and a latex ink applying step of applying a latex ink containing a resin dispersed in a solvent on the undercoat layer, the latex ink applying step being performed subsequent to the undercoat layer forming step.

When applying this manufacturing method to a recording medium formed from a fiber, voids of the fiber can be filled up. Even when applying this manufacturing method to recording media with large surface irregularity, for example, mat paper and corrugated board, the advantageous features of the latex ink can be fully exploited.

By applying the latex ink after the undercoat layer is formed on the recording medium, the surface of the recording medium can become less irregular and resultantly flattened or rendered as flat as possible. Accordingly, by printing an image with the latex ink on the undercoat layer, the image can be printed well in a thinner layer than images printed in the absence of such an undercoat layer. Thus, recording media with surface irregularity can fully take advantage of the useful features of the latex ink. Further advantageously, the layer formed by the latex ink can be flatter, thereby allowing the surface of an obtained printed matter to be more lustrous.

[Recording Medium]

The manufacturing method for the printed matter according to the present disclosure is applicable to various types of recording media. Examples of the recording medium include plastic materials, papers, fabrics, metals, and stones. Of these examples, papers are particularly preferable. Examples of the papers include copy paper, mat paper, glossy paper, different pieces of coating paper, photo paper, book paper, newspaper, corrugated board, and plastic paper.

[Undercoat Layer Forming Step]

In the undercoat layer forming step, the undercoat ink is applied on the recording medium to form the undercoat layer.

In the undercoat layer forming step, the undercoat ink is preferably applied on the recording medium horizontally situated to such an extent that the undercoat ink reaches a point of height equal to or above a highest point of surface irregularity of the recording medium. This allows the undercoat ink to fill in all of dents on the irregular surface of the recording medium, thereby flattening the surface. Accordingly, since the latex ink can be applied on the flattened surface, a layer formed by the latex ink can be thinner and flatter. In this manner, the useful features of the latex ink can be fully exploited.

Preferably, the undercoat layer forming step may be performed at a temperature between room temperature and 40° C. By avoiding high temperatures during the step, energy-saving effect can be expected. Further advantageously, the risk of crimping the recording medium can be avoided.

The room temperature normally refers to temperatures in environments where print devices are used, mostly between 20° C. and 30° C.

The technique for applying the undercoat ink, though not particularly limited, may preferably be ink jetting technique. The ink jetting technique can succeed in accurately applying the undercoat ink to any desired place. The ink jetting technique may be, for example, piezo ink jetting technique. When using an aqueous ink, such as an aqueous latex ink, as the undercoat ink, a thermal jetting technique may be a suitable technique.

[Undercoat Ink]

The undercoat ink used in the manufacturing method for the printed matter according to the present disclosure may be selected from various types of inks, as long as they can provide a primary coating for the latex ink later applied on the undercoat ink layer. Examples of such inks include known primer inks and latex inks.

An example of the primer inks is PR-100 (trade name) supplied by MIMAKI ENGINEERING CO., LTD.

The following advantages can be effectuated by using a latex ink as the undercoat ink. The latex ink is a material that can be well-adhered to various types of recording media. Therefore, printing can be performed on variously different recording media by using the latex ink.

The undercoat ink may be selected from inks in different colors including transparent and white inks. Any suitable one of such inks may be arbitrarily selected depending on a printed matter desirably obtained.

[Latex Ink Applying Step]

In the latex ink applying step, the latex ink is applied on the undercoat layer. As a result, an image can be printed well in a thinner layer than images printed in the absence of such an undercoat layer. Thus, recording media with surface irregularity can fully take advantage of the useful features of the latex ink.

The technique for applying the latex ink, though not particularly limited, may preferably be ink jetting technique as in the case of the undercoat ink. Using a print device with heads respectively for the undercoat ink and latex ink installed in one carriage, a printed matter can be produced by one device alone. The ink jetting technique may be, for example, piezo ink jetting technique. When using an aqueous latex ink as the undercoat ink, a thermal jetting technique may be a suitable technique.

Preferably, the recording medium is heated while the latex ink is being applied thereon. This allows the latex ink to rapidly dry during the printing operation. Advantageously, the layer formed by the latex ink can become thinner, and the latex ink thus dried fast can be prevented from smearing. The resultant layer, therefore, can be further improved in flatness. A suitable temperature during the heating may be decided depending on the type of the latex ink, for example, 40° C. to 70° C. The recording medium may be heated by any suitable means. For example, a heater may be embedded in a platen on which the recording medium is placed during the printing operation, so that the recording medium can be heated by the platen during the printing operation.

[Latex Ink]

The latex ink used in the manufacturing method for the printed matter according to the present disclosure is a latex ink containing a resin, a solvent, and a coloring agent in which the resin is dispersed or emulsified in the solvent. The latex inks are favorable materials for their low environmental load, and can be suitably used to perform printing on variously different recording media. The latex inks are further advantageous in that dark colors can be produced with thinner layers. By virtue of the availability of ink jetting technique, a print device used in this method can be further structurally simplified, downsized, and reduced in cost as compared to in the conventional transfer printing technique. These advantageous features can be expected to promise a broad range of applicability in the field of digital offset printing technique.

Preferably, the latex ink may be an aqueous latex ink. The aqueous latex ink refers to an ink containing water or a hydrophilic organic solvent and a resin in which the resin is emulsified or suspended in the hydrophilic organic solvent or water. The aqueous latex ink is an even safer material with lower environmental load. Such an aqueous latex ink, therefore, may be suitable for printing on labels and seals adhered to, for example, food containers.

[Resin]

The resin contained in the latex ink may be selected from the following non-limiting examples; water-soluble vinyl-based resins, acrylic resins, alkyd-based resins, polyester-based resins, polyurethane-based resins, silicon-based resins, fluororesins, epoxy-based resins, phenoxy-based resins, polyolefin-based resins, and modified resins of these examples. Of these examples, the latex ink is preferably selected from acrylic resins, water-soluble polyurethane-based resins, water-soluble polyester-based resins, and water-soluble acrylic resins. Among the preferable examples, acrylic resins are particularly preferable.

The resin contained in the latex ink may be one selected from the examples, or two or more of these resins may be combined and used. The resin content may be arbitrarily decided depending on which of the resins is used. For example, the resin content may be equal to or greater than 1 wt. %, or preferably equal to or greater than 2 wt. % for the whole quantity of the latex ink. Further, the resin content may be equal to or less than 20 wt. %, or preferably equal to or less than 10 wt. % for the whole quantity of the latex ink.

[Solvent]

The solvent contained in the latex ink, though not particularly limited, is preferably at least one of water and a water-soluble organic solvent.

Specific examples of the water-soluble organic solvent are: multivalent alcohols including ethylene glycol, diethylene glycol, triethylene glycol, propylene glycol, dipropylene glycol, tripropylene glycol, tetraethylene glycol, polyethylene glycol, polypropylene glycol, 1,3-butanediol, 3-methyl-1,3-butanediol, 2,3-butanediol, 1,4-butanediol, 1,5-pentanediol, 1,6-hexanediol, glycerols, 1,2,6-hexanetriol, 2,4-butanetriol, 1,2,3-butanetriol, 2-methyl-2,4-pentanediol, Petriol, and 3-methoxy-3-methyl-1-butanediol; multivalent alcohol alkyl ethers including ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; multivalent alcohol aryl ethers including ethylene glycol monophenyl ether, ethylene glycol monobenzyl ether, dipropylene glycol monobutyl ether, tripropylene glycol monobutyl ether, diethylene glycol isobutyl ether, triethylene glycol isobutyl ether, and diethylene glycol isopropyl ether; nitrogen-containing heterocyclic compounds including 2-pyrrolidone, N-methyl-2-pyrrolidone, N-hydroxyethyl-2-pyrrolidone, 1,3-dimethylimidazolidinone, ε-caprolactam, and γ-butyrolactone; amides including formamide, N-methyl formamide, and N,N-dimethyl formamide; amines including monoethanol amine, diethanol amine, Methanol amine, monoethyl amine, diethyl amine, and triethyl amine; sulfur-containing compounds including dimethyl sulfoxide, sulfolane, thiodiethanol, and thiodiglycol; propylene carbonate; ethylene carbonate; trimethylolpropane; tetramethylurea; and urea.

The water-soluble organic solvent of the latex ink may be one selected from these examples, or two or more of them may be combined and used.

The content of the solvent in the latex ink may be suitably decided depending on the intended purpose of the printing. For example, the solvent content may be preferably equal to or greater than 50 wt. %, more preferably equal to or greater than 60 wt. %, or most preferably equal to or greater than 70 wt. % for the whole quantity of the latex ink. The latex ink may preferably have a greater solvent content than in the conventional water-based inks for ink jetting. As the result, a printed matter with even lower environmental load may be provided.

[Coloring Agent]

The coloring agent contained in the latex ink may be suitably decided depending on the intended purpose of the printing. Examples of the coloring agent include dyes and pigments.

For better solubility of the coloring agent in the latex ink, a material easily soluble in the water-soluble organic solvent may preferably be used as the coloring agent. Such a coloring agent preferably has a solubility of 2 g/L or more for a ketone-based solvent. More preferably, the coloring agent has a solubility of 20 g/L to 600 g/L for a ketone-based solvent.

The content of the coloring agent in the latex ink is preferably 10 to 200 parts by weight, or more preferably 25 to 150 parts by weight for 100 parts by weight of the latex ink.

[Dye]

Specific examples of the dye contained in the latex ink as the coloring agent include acid dyes and food dyes, such as C.I. acid yellows 17, 23, 42, 44, 79, and 142; C.I. acid reds 1, 8, 13, 14, 18, 26, 27, 35, 37, 42, 52, 82, 87, 89, 92, 97, 106, 111, 114, 115, 134, 186, 249, 254, and 289; C.I. acid blues 9, 29, 45, 92, and 249; C.I. acid blacks 1, 2, 7, 24, 26, and 94; C.I. food yellows 3 and 4; C.I. food reds 7, 9, and 14; and C.I. food blacks 1 and 2.

The examples may further include direct dyes, such as C.I. direct yellows 1, 12, 24, 26, 33, 44, 50, 86, 120, 132, 142, and 144; C.I. direct reds 1, 4, 9, 13, 17, 20, 28, 31, 39, 80, 81, 83, 89, 225, and 227; C.I. direct oranges 26, 29, 62, and 102; C.I. direct blues 1, 2, 6, 15, 22, 25, 71, 76, 79, 86, 87, 90, 98, 163, 165, 199, and 202; and C.I. direct blacks 19, 22, 32, 38, 51, 56, 71, 74, 75, 77, 154, 168, and 171.

The examples may further include basic dyes, such as C.I. basic yellows 1, 2, 11, 13, 14, 15, 19, 21, 23, 24, 25, 28, 29, 32, 36, 40, 41, 45, 49, 51, 53, 63, 64, 65, 67, 70, 73, 77, 87, and 91; C.I. basic reds 2, 12, 13, 14, 15, 18, 22, 23, 24, 27, 29, 35, 36, 38, 39, 46, 49, 51, 52, 54, 59, 68, 69, 70, 73, 78, 82, 102, 104, 109, and 112; C.I. basic blues 1, 3, 5, 7, 9, 21, 22, 26, 35, 41, 45, 47, 54, 62, 65, 66, 67, 69, 75, 77, 78, 89, 92, 93, 105, 117, 120, 122, 124, 129, 137, 141, 147, and 155; and C.I. basic blacks 2 and 8.

The examples may further include reactive dyes, such as C.I. reactive blacks 3, 4, 7, 11, 12, and 17; C.I. reactive yellows 1, 5, 11, 13, 14, 20, 21, 22, 25, 40, 47, 51, 55, 65, and 67; C.I. reactive reds 1, 14, 17, 25, 26, 32, 37, 44, 46, 55, 60, 66, 74, 79, 96, and 97; and C.I. reactive blues 1, 2, 7, 14, 15, 23, 32, 35, 38, 41, 63, 80, and 95.

[Pigment]

The pigment used as the coloring agent may be, for example, a black pigment known as carbon black. A color pigment may be used, examples of which may include anthraquinones, phthalocyanine blues, phthalocyanine greens, diazos, monoazos, pyranthrones, perylenes, heterocyclic yellows, quinacridones, and (thio)indigoids. Typical examples of the phthalocyanine blues include copper phthalocyanine blue and its derivative (pigment blue 15). Typical examples of the quinacridones include pigment orange 48, pigment orange 49, pigment red 122, pigment red 192, pigment red 202, pigment red 206, pigment red 207, pigment red 209, pigment violet 19, and pigment violet 42. Typical examples of the anthraquinones include pigment red 43, pigment red 194 (perynone red), pigment red 216 (brominated pyranthrone red), and pigment red 226 (pyranthrone red). Typical examples of the perylenes include pigment red 123 (vermillion), pigment red 149 (scarlet), pigment red 179 (maroon), pigment red 190 (red), pigment violets, pigment red 189 (shade of red with yellow), and pigment red 224. Typical examples of the (thio)indigoids include pigment red 86, pigment red 87, pigment red 88, pigment red 181, pigment red 198, pigment violet 36, and pigment violet 38. Typical examples of the heterocyclic yellows include pigment yellow 117 and pigment yellow 138.

The coloring agent contained in the latex ink may be any one suitably selected from the before-mentioned examples depending on the intended purpose of the printing. One of these pigments or dyes may be singly used, or two or more of them may be combined and used.

[Other Ingredients]

The latex ink used in the manufacturing method for the printed matter according to the present disclosure may contain other ingredients in addition to the above-mentioned solvent, resin, and coloring agent. Examples of such additives include a disperser, an anti-fungal agent, an anti-corrosive agent, a pH regulator, and a surfactant.

[Disperser]

Examples of the disperser include polymeric dispersers, such as polyacrylic acids, polymethacrylic acids, acrylic acid-acrylonitrile copolymers, vinyl acetate-acrylic acid ester copolymers, acrylic acid-acrylic acid alkyl ester copolymers, styrene-acrylic acid copolymers, styrene-methacrylic acid copolymers, styrene-acrylic acid-acrylic acid alkyl ester copolymers, styrene-methacrylic acid-acrylic acid alkyl ester copolymers, styrene-α-methyl styrene-acrylic acid copolymers, styrene-α-methyl styrene-acrylic acid copolymer-acrylic acid alkyl ester copolymers, styrene-maleic acid copolymers, vinyl naphthalene-maleic acid copolymers, vinyl acetate-ethylene copolymers, vinyl acetate-fatty acid vinyl ethylene copolymers, vinyl acetate-maleic acid ester copolymers, vinyl acetate-crotonic acid copolymers, and vinyl acetate-acrylic acid copolymers.

[Anti-fungal Agent]

The anti-fungal agent may be, for example, 1,2-benzisothiazolin-3-one. The latex ink containing the anti-fungal agent can excel in fungal resistance, while ensuring reliabilities such as storage stability and discharge stability.

By controlling the content of 1,2-benzisothiazolin-3-one, unfavorable events, such as aggregation of particles and thickening of the ink, can be prevented. This allows an expected ink performance to be exerted over a long period of time. In the event of adding 1,2-benzisothiazolin-3-one to the latex ink as the anti-fungal agent, the content of this substance as an active ingredient may preferably be 0.01 to 0.04 parts by weight for the whole quantity of the ink. This substance, with its content equal to or greater than 0.01 parts by weight, can fully exert the anti-fungal effect. The content of this substance equal to or less than 0.04 parts by weight can effectively serve to suppress aggregation of particles during long-term storage of the ink (for example, two years at room temperature, one to three months at 50 to 60° C.). This can further advantageously solve the problem of the ink possibly thickened by 50% to 100% of its initial viscosity, providing an improved stability during long-term storage. As a result, the ink may maintain its originally intended print performance for a long period of time.

[Anti-Corrosive Agent]

Examples of the anti-corrosive agent include acid sulfite, sodium thiosulfate, ammonium thiodiglycolate, diisopropyl ammonium nitrate, pentaerythritol tetranitrate, and dicyclohexyl ammonium nitrate.

[pH Regulator]

A substance used as the pH regulator may be optionally decided as long as the pH can be regulated to values equal to or greater than 7 without adversely affecting the prepared ink.

Examples of the pH regulator are: amines including diethanolamines and triethanolamines; hydroxides of alkali metal elements including lithium hydroxide, sodium hydroxide, and potassium hydroxide; ammonium hydroxide; quaternary ammonium hydroxide; quaternary phosphonium hydroxide; alkali metal carbonates including lithium carbonate, sodium carbonate, and potassium carbonate; and aminopropanediol derivatives. The aminopropanediol derivatives are water-soluble organic basic compounds. Examples of such compounds include 1-amino-2,3-propanediol, 1-methylamino-2,3-propanediol, 2-amino-2-methyl-1,3-propanediol, and 2-amino-2-ethyl-1,3-propanediol. Of these examples, 2-amino-2-ethyl-1,3-propanediol is particularly preferable.

[Surfactant]

Examples of the surfactant include polyalkylene glycol surfactants. The polyalkylene glycol surfactants are ethylene oxide adducts. Other usable examples may include adducts with ethylene oxide partly substituted by alkylene oxide, such as propylene oxide or butylene oxide, to such an extent that water solubility is not undermined, where the substitution ratio is preferably equal to or less than 50%. The polyalkylene glycol surfactants may preferably have HLB (hydrophile-lipophile balance) ranging from 13 to 19. The HLB regulated to stay within the range serves to further improve the dispersibility.

[Embodiment of Manufacturing Method for the Printed Matter According to the Disclosure]

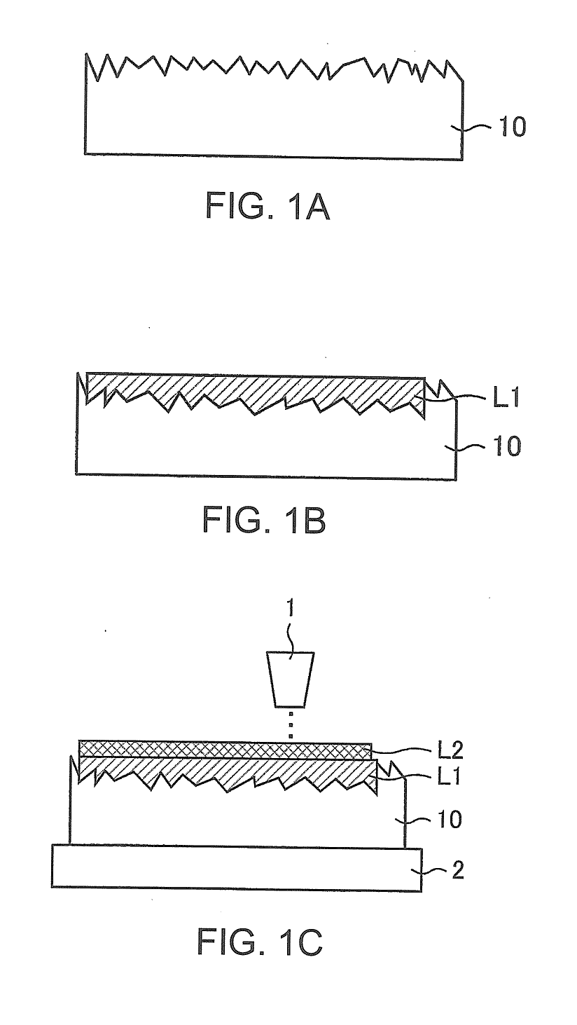

Next, an embodiment of the manufacturing method for the printed matter according to the present disclosure is hereinafter described with reference to FIGS. 1A˜1C. FIGS. 1A˜1C are schematic drawings of steps of the manufacturing method for the printed matter in the embodiment according to the present disclosure.

In the embodiment described herein, a latex ink contains a coloring agent, whereas an undercoat ink contains no coloring agent. According to the embodiment, an absorptive mat paper 10 with large surface irregularity is used as the recording medium as illustrated in FIG. 1A.

As illustrated in FIG. 1B, in the undercoat layer forming step, the undercoat ink is applied on the absorptive mat paper 10 to form an undercoat layer L1. The undercoat ink is applied at a temperature between room temperature and 40° C. The undercoat ink is applied on the mat paper 10 horizontally situated to such an extent that the surface of the undercoat layer L1 reaches a point of height equal to or above the highest point of the surface irregularity of the absorptive mat paper 10. This allows the undercoat ink to fill in all of dents on the irregular surface, thereby flattening the surface of the absorptive mat paper 10. Accordingly, since the latex ink can be applied on the flattened surface, a layer formed by the latex can be thinner and flatter. In this manner, the useful features of the latex ink can be fully exploited.

By avoiding high temperatures during the step, energy-saving effect can be expected. Further advantageously, the risk of crimping the absorptive mat paper 10 can be avoided.

According to this embodiment, the undercoat ink is applied by ink jetting. In an inkjet head 1 illustrated in FIG. 1C described later, an undercoat ink discharge head is also installed. This can expedite the production of a printed matter.

As illustrated in FIG. 1C, in the latex ink applying step, the latex ink is applied through the inkjet head 1 on the undercoat layer L1 to form a latex ink layer L2. The absorptive mat paper 10 is heated by a heater 2 to stay at 40° C. to 70° C. While the struck latex ink is being heated and dried, a resin contained in the latex ink is dissolved and fixedly bonded. The surface on which the latex ink is to be discharged is already flattened by the undercoat layer L1. Therefore, the latex ink layer L2 formed thereon can also be thinned and flattened. Thus, the absorptive mat paper 10 with large surface irregularity can fully take advantage of the usable features of the latex ink to produce a dark color with a thinner layer.

### INDUSTRIAL APPLICABILITY

The present disclosure is applicable to printing techniques for various recording media such as plastic materials, papers, fabrics, metals, and stones.

What is claimed is:

1. A manufacturing method for a printed matter, comprising:
an undercoat layer forming step of applying an undercoat ink on a recording medium to form an undercoat layer; and
a latex ink applying step of applying a latex ink containing a resin dispersed in a solvent on the undercoat layer, the latex ink applying step being performed subsequent to the undercoat layer forming step.

2. The manufacturing method for the printed matter according to claim 1, wherein
in the undercoat layer forming step, the undercoat ink is applied on the recording medium to such an extent that the undercoat ink reaches a point of height equal to or above a highest point of surface roughness of the recording medium horizontally situated.

3. The manufacturing method for the printed matter according to claim 1, wherein
the undercoat layer forming step is performed at a temperature from room temperature to 40° C.

4. The manufacturing method for the printed matter according to claim 1, wherein
the latex ink includes an aqueous latex ink.

5. The manufacturing method for the printed matter according to claim 2, wherein
the latex ink includes an aqueous latex ink.

6. The manufacturing method for the printed matter according to claim 3, wherein
the latex ink includes an aqueous latex ink.

7. The manufacturing method for the printed matter according to claim 1, wherein
the undercoat ink includes a latex ink.

8. The manufacturing method for the printed matter according to claim 2, wherein
the undercoat ink includes a latex ink.

9. The manufacturing method for the printed matter according to claim 3, wherein
the undercoat ink includes a latex ink.

10. The manufacturing method for the printed matter according to claim 4, wherein
the undercoat ink includes a latex ink.
